(19) United States
(12) Patent Application Publication
(10) Pub. No.: US 2023/0038240 A1
(43) Pub. Date: Feb. 9, 2023

(54) THREE-DIMENSIONAL (3D) IMAGE MODELING SYSTEMS AND METHODS FOR AUTOMATICALLY GENERATING PHOTOREALISTIC, VIRTUAL 3D PACKAGING AND PRODUCT MODELS FROM 2D IMAGING ASSETS AND DIMENSIONAL DATA

(71) Applicant: The Procter & Gamble Company, Cincinnati, OH (US)

(72) Inventors: Rachel Wiley, Cincinnati, OH (US); David A. Lombardi, JR., Cincinnati, OH (US); Diana Jobson Cheshire, Wyoming, OH (US)

(21) Appl. No.: 17/392,331

(22) Filed: Aug. 3, 2021

(51) Int. Cl. G06T 17/20; G06F 16/55; G06T 15/04; G06T 19/20

(52) U.S. Cl. CPC G06T 17/20; G06F 16/55; G06T 15/04; G06T 19/20; G06T 2219/2004; G06T 2200/24

(57) ABSTRACT

Three-dimensional (3D) modeling systems and methods are described for automatically generating photorealistic, virtual 3D package and product models from two-dimensional (2D) imaging assets and dimensional data. The 3D modeling systems and methods include storing, by a memory with one or more processors, 2D imaging assets and dimensional datasets, obtaining, with an imaging asset manipulation script, a shape classification defining a real-world product or product package to be virtually modeled in 3D space, generating, with the imaging asset manipulation script, a spline based on an alpha channel extracted from a 2D imaging asset depicting the real-world product or package, and generating, with the imaging asset manipulation script, a parametric model based on the spline, the dimensional dataset, and the shape classification. A virtual 3D model is generated based on the parametric model and rendered, via a graphical display or environment, as a photorealistic image representing the real-world product or product package.

### FIELD OF THE DISCLOSURE

The present disclosure generally relates to three-dimensional (3D) modeling systems and methods, and more particularly to, 3D modeling systems and methods for automatically generating photorealistic, virtual 3D package and product models from two-dimensional (2D) imaging assets and dimensional data.

### BACKGROUND

In the consumer goods industry, three-dimensional (3D) models of physical products or packages corresponding to real-world products or packages are useful in virtual reality shopping environments, e-commerce environments and gaming environments. Today, creating these models is a costly and time consuming process that involves manually modeling or scanning the actual 3D shape to create a surface mesh and applying textures representing the surface colors, materials and decoration. Artists must adjust models by hand to match the visual acuity requirements for the store virtual reality shopping environments, e-commerce environments, or gaming environments where the 3D models will be used. As consumer products often change, this must be repeated frequently resulting in lost effort and lost investment, which has been a barrier to widespread adoption of virtual reality shopping environments.

For the foregoing reasons, there is a need for 3D modeling systems and methods for automatically generating photorealistic, virtual 3D package and product models from two-dimensional (2D) imaging assets and dimensional data.

### BRIEF SUMMARY

The 3D modeling systems and methods described herein provide for rapid, automatic creation or generation of high-quality, realistic virtual three-dimensional (3D) package and product models from two-dimensional (2D) imaging assets and dimensional data. That is, implementation of the 3D modeling systems and methods described herein allow for such creation or generation in a fraction of the time compared with conventional, prior art 3D modeling techniques. In particular, highly accurate (e.g., in terms of dimensions, physical appearance, etc.) virtual packages and products can be rendered quickly and for low cost. Such virtual packages and products can be used in virtual reality shopping environments, e-commerce environments, or gaming environments, etc., and can be much more easily modified based on changes in product or packaging design as needed, compared to prior art techniques.

Generally, the 3D modeling systems and methods described herein provide a unique data-driven solution and an automated platform for generating photorealistic, virtual 3D package and product models from 2D imaging assets and dimensional data. The 3D modeling systems and methods described herein may be applied to various categories of products and packages, e.g., including those in the consumer goods industry. Such products and packages may include those in consumer products industry including hair care, grooming industry, laundry, toiletry, etc. and the like. For example, a highly accurate, photorealistic, virtual 3D model of a product and/or package (e.g., a shampoo bottle) may be generated, assembled, and/or otherwise created from 2D imaging assets and dimensional data. In various aspects, such virtual 3D models can be further manipulated, e.g., in a visualization editor. In addition, in some aspects, such virtual 3D models can be imported into an immersive interactive virtual environment. In this way, the virtual 3D models can become part of a product and package data record for perpetual reuse in creating new and/or addition virtual 3D models for new, additional, or future products or packages.

The 3D modeling systems and methods described herein differ from the standard industry, or prior art, approach of creating 3D virtual models whereby 3D packaging or product models are created by extracting a profile from a library of existing 3D shapes with predefined cross sections (horizontal and vertical), and distorting a mesh to fit the profile. Such prior art methods lack the fidelity and speed of the 3D modeling systems and methods described herein, and result in 3D models that are more difficult to modify. In particular, such prior art methods involve spreading the surface image mesh data equally across the surface such that complex surface segments lose fidelity (i.e., curves and corners are distorted). Moreover, using such prior art methods, there is no way to preserve corner and surface curve details, resulting in chunky meshes and low fidelity for some shapes. Furthermore, such prior art methods lack the ability to modify the 3D model once it is created to make tweaks and improvements if needed.

Accordingly, as described herein for some aspects, a 3D modeling system is configured to automatically generate photorealistic, virtual 3D package and product models from 2D imaging assets and dimensional data. The 3D modeling system may include one or more processors and an imaging asset manipulation script configured to execute on the one or more processors. In addition, the 3D modeling system may further include a memory configured to store 2D imaging assets and dimensional datasets accessible by the imaging asset manipulation script. The one or more processors of the 3D modeling system may be configured to obtain a shape classification defining a real-world product or product package to be virtually modeled in 3D space. The one or more processors of the 3D modeling system may be configured to obtain a dimensional dataset defining product or package measurements of the real-world product or product package to be virtually modeled in 3D space. The one or more processors of the 3D modeling system may be configured to generate a spline, based on a 2D image asset, wherein the 2D image asset is selected from the 2D imaging assets, and wherein the 2D image asset depicts the real-world product or product package, the spline comprising a plurality of points positioned along a perimeter of a shape silhouette of the real-world product or product package depicted in the 2D image asset. The one or more processors of the 3D modeling system may be configured to generate a parametric model based on the spline, the dimensional dataset, and the shape classification. The one or more processors of the 3D modeling system may be configured to generate a virtual 3D model of the real-world product or product package based on the parametric model and one or more attributes corresponding to the real-world product or product package. The one or more processors of the 3D modeling system may be configured to render, via a graphical display or environment, the virtual 3D model as a photorealistic image representing the real-world product or product package in a virtual 3D space.

In addition, as described in various aspects herein, a 3D modeling method is disclosed for automatically generating photorealistic, virtual 3D package and product models from 2D imaging assets and dimensional data. The 3D modeling method includes obtaining, with an imaging asset manipulation script implemented on the one or more processors by one or more processors, a shape classification defining a real-world product or product package to be virtually modeled in 3D space. The 3D modeling method may further include obtaining, by the one or more processors, a dimensional dataset defining product or package measurements of the real-world product or product package to be virtually modeled in 3D space. The 3D modeling method may further include generating, by the one or more processors, based on a 2D image asset, wherein the 2D image asset is selected from the 2D imaging assets, and wherein the 2D image asset depicts the real-world product or product package, the spline comprising a plurality of points positioned along a perimeter of a shape silhouette of the real-world product or product package depicted in the 2D image asset. The 3D modeling method may further include generating, by the one or more processors, a parametric model based on the spline, the dimensional dataset, and the shape classification. The 3D modeling method may further include generating, by the one or more processors, a virtual 3D model of the real-world product or product package based on the parametric model and one or more attributes corresponding to the real-world product or product package. The 3D modeling method may further include rendering, by the one or more processors, via a graphical display or environment, the virtual 3D model as a photorealistic image representing the real-world product or product package in a virtual 3D space.

In addition, as described in various aspects herein, a tangible, non-transitory computer-readable medium is disclosed, storing instructions for automatically generating photorealistic, virtual 3D package and product models from 2D imaging assets and dimensional data. The instructions, when executed by one or more processors, cause the one or more processors to obtain a shape classification defining a real-world product or product package to be virtually modeled in 3D space. The instructions, when executed by one or more processors, may further cause the one or more processors to obtain a dimensional dataset defining product or package measurements of the real-world product or product package to be virtually modeled in 3D space. The instructions, when executed by one or more processors, may further cause the one or more processors to generate a spline, based on a 2D image asset, wherein the 2D image asset is selected from the 2D imaging assets, and wherein the 2D image asset depicts the real-world product or product package, the spline comprising a plurality of points positioned along a perimeter of a shape silhouette of the real-world product or product package depicted in the 2D image asset. The instructions, when executed by one or more processors, may further cause the one or more processors to generate a parametric model based on the spline, the dimensional dataset, and the shape classification. The instructions, when executed by one or more processors, may further cause the one or more processors to generate a virtual 3D model of the real-world product or product package based on the parametric model and one or more attributes corresponding to the real-world product or product package. The instructions, when executed by one or more processors, may further cause the one or more processors to render, via a graphical display or environment, the virtual 3D model as a photorealistic image representing the real-world product or product package in a virtual 3D space.

In accordance with the above, and with the disclosure herein, the present disclosure includes improvements in computer functionality or in improvements to other technologies at least because, e.g., the disclosed 3D modeling systems and methods automatically generate photorealistic, virtual 3D package and product models from 2D imaging assets and dimensional data. In this way, the 3D modeling systems and methods may flexibly, and efficiently, produce photorealistic image(s), as described herein, which improves the performance, speed, and efficiency of the underlying computing device(s), e.g., processors, memories, and/or servers, because such computing devices are freed from computational and memory extensive tasks regarding manually adjusting 3D models to match visual acuity requirements for a given virtual environment, and creating new 3D models corresponding to real-world products or product packages each time a change is made to the product or product package, which therefore avoids the reuse of memory and processor resources. That is, the present disclosure describes improvements in the functioning of the computer itself or “any other technology or technical field” because the computing devices upon which the 3D modeling systems and methods are implemented are enhanced by an imaging asset manipulation script and an efficient virtual 3D model generation algorithm that, together, increase the fidelity, efficiency, and speed of design of photorealistic images representing real-world products or product packages. This improves over the prior art at least because prior art systems resulted in low fidelity 3D models that were difficult to re-use, and, therefore required increased memory and processing power, at least over time, to develop and modify designs for real-world product or product packages. In contrast, the systems and methods described herein utilize less memory and processing power to produce a high fidelity 3D model, as compared to prior art systems and methods. Moreover, less memory is required for both saving and accessing the 3D models created by the systems and methods described herein, as compared to prior art systems and methods. For example, the processor and memory resources used by the 3D modeling systems and methods are typically less than that of prior art systems for the same design over time. Not only do the disclosed 3D modeling systems and methods use fewer computational resources, they are much faster, and therefore more efficient, for generating virtual 3D models and/or photorealistic images representing real-world product(s) or product package(s). In one example, the disclosed 3D modeling systems and methods reduced the amount of time required to create each virtual 3D model from four hours (i.e., when using prior art systems and methods) to three to five minutes (using the disclosed 3D modeling systems and methods).

In addition, with respect to certain aspects, the present disclosure includes effecting a transformation or reduction of a particular article to a different state or thing, e.g., generating a virtual 3D model of a real-world product or product package, from 2D imaging assets and dimensional data and, also, in some aspects, initiating the creation of the real-world product or product package based on the virtual 3D model.

Still further, the present disclosure includes specific limitations and features other than what is well-understood, routine, conventional activity in the field, or adding unconventional steps that confine the claim to a particular useful application, e.g., automatically generating photorealistic, virtual 3D package and product models from 2D imaging assets and dimensional data.

Additional advantages will become more apparent to those of ordinary skill in the art from the following description of the preferred aspects which have been shown and described by way of illustration. As will be realized, the present aspects may be capable of other and different aspects, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the system and methods disclosed therein. It should be understood that each Figure depicts an aspect of a particular aspect of the disclosed system and methods, and that each of the Figures is intended to accord with a possible aspect thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present aspects are not limited to the precise arrangements and instrumentalities shown, wherein:

FIG. 1 illustrates an example three-dimensional (3D) modeling system or platform configured to automatically generate photorealistic, virtual 3D package and product models from two-dimensional (2D) imaging assets and dimensional data, in accordance with various aspects disclosed herein.

FIG. 2A illustrates a flow diagram depicting a database configured to store 2D imaging assets, product or package measurements, and shape category classifications, for real-world products or product packages, and an example imaging asset manipulation script for extracting 2D imaging assets, product or package measurements, and shape category classifications for a particular real-world product or product package to be virtually modeled in 3D space, in accordance with various aspects disclosed herein.

FIG. 2B illustrates a visualization or rendering of various possible shape category classifications, as described by the flow diagram of FIG. 2A, in accordance with various aspects disclosed herein.

FIG. 2C illustrates a visualization or rendering of a 2D imaging asset and an alpha channel extracted from a 2D imaging asset depicting a real-world product or product package, as described by the flow diagram of FIG. 2A, in accordance with various aspects disclosed herein.

FIG. 3A illustrates a flow diagram for generating a spline, based on an alpha channel extracted from a 2D imaging asset depicting a real-world product or product package, such as the alpha channel of FIG. 2C, in accordance with various aspects disclosed herein.

FIG. 3B illustrates a visualization or rendering of a spline generated based on an alpha channel extracted from a 2D imaging asset depicting a real-world product or product package, as described by the flow diagram of FIG. 3A, in accordance with various aspects disclosed herein.

FIG. 3C illustrates a visualization or rendering of a spline generated based on an alpha channel extracted from a 2D imaging asset depicting a real-world product or product package, with key segments associated with elements within the shape of the real-world product or product package isolated, as described by the flow diagram of FIG. 3A, in accordance with various aspects disclosed herein.

FIG. 4A illustrates a flow diagram for generating a parametric model based on a spline, a dimensional dataset, and a shape classification for a real-world product or product package and generating a virtual 3D model of the real-world product or product package based on the parametric model and one or more attributes corresponding to the real-world product or product package, in accordance with various aspects disclosed herein.

FIG. 4B illustrates a visualization or rendering of a parametric model generated based on a spline, a dimensional dataset, and a shape classification for a real-world product or product package, as described by the flow diagram of FIG. 4A, in accordance with various aspects disclosed herein.

FIG. 4C illustrates a visualization or rendering of a virtual 3D model of a real-world product or product package generated based on a parametric model generated based on a spline, a dimensional dataset, and a shape classification for a real-world product or product package, and one or more attributes corresponding to the real-world product or product package, as described by the flow diagram of FIG. 4A, in accordance with various aspects disclosed herein.

FIG. 5A illustrates a flow diagram for refining a virtual 3D model of a real-world product or product package generated based on a parametric model generated based on a spline, a dimensional dataset, and a shape classification for a real-world product or product package, such as the virtual 3D model of the real-world product or product package shown at FIG. 4C, in accordance with various aspects disclosed herein.

FIG. 5B illustrates an example user interface for an example visualization editor, through which a user may adjust or refine a virtual 3D model of a real-world product or product package, such as the virtual 3D model of the real-world product or product package shown at FIG. 4C, in accordance with various aspects disclosed herein.

FIG. 5C illustrates a visualization or rendering of an example adjustment or refinement as may be applied to a spline associated with a virtual 3D model of a real-world product or product package such as the virtual 3D model of the real-world product or product package shown at FIG. 4C, via the example visualization editor of FIG. 5B, in accordance with various aspects disclosed herein.

FIG. 5D illustrates a visualization or rendering of another example adjustment or refinement as may be applied to a virtual 3D model of a real-world product or product package such as the virtual 3D model of the real-world product or product package shown at FIG. 4C, via the example visualization editor of FIG. 5B, in accordance with various aspects disclosed herein.

FIG. 5E illustrates a visualization or rendering of still another example adjustment or refinement as may be applied to a virtual 3D model of a real-world product or product package such as the virtual 3D model of the real-world product or product package shown at FIG. 4C, via the example visualization editor of FIG. 5B, in accordance with various aspects disclosed herein.

FIG. 6 illustrates a flow diagram or algorithm of an example 3D modeling method for automatically generating photorealistic, virtual 3D package and product models from two-dimensional (2D) imaging assets and dimensional data, in accordance with various aspects disclosed herein.

The Figures depict preferred aspects for purposes of illustration only. Alternative aspects of the systems and methods illustrated herein may be employed without departing from the principles of the invention described herein.

### DETAILED DESCRIPTION

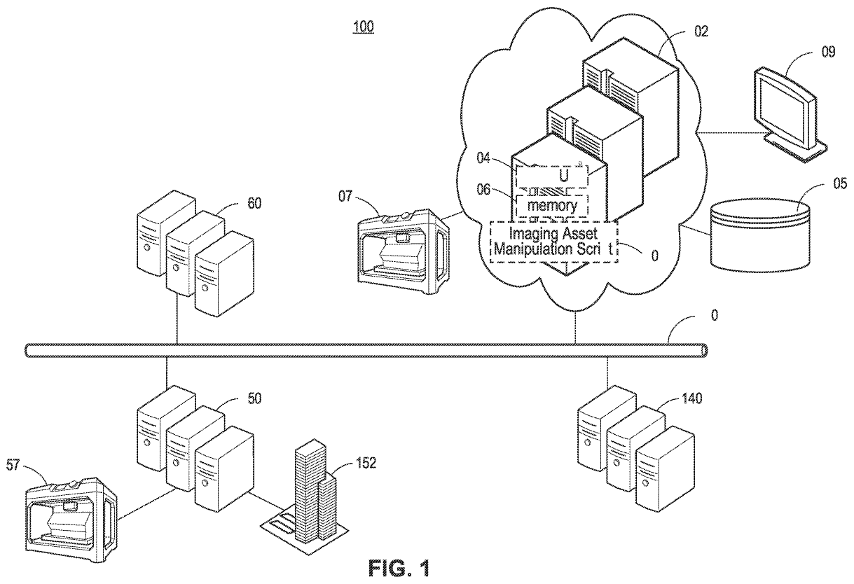

FIG. 1 illustrates an example three-dimensional (3D) modeling system 100 or platform configured to automatically generate photorealistic, virtual 3D package and product models from two-dimensional (2D) imaging assets and dimensional data, in accordance with various aspects disclosed herein. In the example aspect of FIG. 1, 3D modeling system 100 includes server(s) 102, which may be referred to herein as “modeling server(s),” and which may comprise one or more computer servers. In various aspects, server(s) 102 comprise multiple servers, which may comprise multiple, redundant, or replicated servers as part of a server farm. In still further aspects, server(s) 102 may be implemented as cloud-based servers. For example, server(s) 102 may be a cloud-based platform such as MICROSOFT AZURE, AMAZON AWS, GOOGLE CLOUD platform, or the like.

Server(s) 102 may include one or more processor(s) 104 as well as one or more computer memories 106. Memories 106 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, Micros cards, and others. Memorie(s) 106 may store an operating system (OS) (e.g., Microsoft Windows, Linux, Unix, etc.) capable of facilitating the functionalities, apps, methods, or other software as discussed herein. Memorie(s) 106 may also store machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For example, at least some of the software, instructions, scripts, applications, software components, or APIs may include, otherwise be part of, an imaging asset manipulation script, machine learning component, and/or other such software, where each are configured to facilitate their various functionalities as described herein. It should be appreciated that one or more other applications or scripts, such as those described herein, may be envisioned and that are executed by processor(s) 104. In addition, while FIG. 1 shows implementation of the systems and methods on server(s) 102, it should be appreciated that the systems and methods herein may be implemented by a non-server computing system that includes one or more processors.

Processor(s) 104 may be connected to memories 106 via a computer bus responsible for transmitting electronic data, data packets, or otherwise electronic signals to and from processor(s) 104 and memories 106 in order to implement or perform the machine readable instructions, methods, processes, scripts, elements or limitations, as illustrated, depicted, or described for the various flowcharts, illustrations, diagrams, figures, and/or other disclosure herein.

Processor(s) 104 may interface with memory 106 via the computer bus to execute the operating system (OS). Processor(s) 104 may also interface with computer memory 106 via the computer bus to create, read, update, delete, or otherwise access or interact with the data stored in memory, including in memories 106 and/or the database 105 (e.g., a relational database, such as Oracle, DB2, MySQL, or a NoSQL based database, such as MongoDB). The data stored in memories 106 and/or the database 105 may include all or part of any of the scripts, data or information described herein, including, for example the imaging asset manipulation script, and/or the 2D imaging assets as accessible by the imaging asset manipulation script.

As described herein a “memory” may refer to either memory 106 and/or database 105. Such memory may be configured to store 2D imaging assets accessible by processor(s) 104, scripts, application, or other software, e.g., including an imaging asset manipulation script described herein.

In some aspects, database 105 may be a product lifecycle management (PLM) database or system. Generally, a PLM database or system is implemented as an information management system that can integrate data, processes, and other business systems within an enterprise or platform, such as the platform depicted for 3D modeling system 100. A PLM database or system generally includes software for managing information (e.g., 2D imaging assets) throughout an entire lifecycle of a product/package in an efficient and cost-effectivities manner. The lifecycle may include lifecycle stages from ideation, design and manufacture, through service and disposal. In some aspects, database 105 may store digital PLM objects (e.g., digital 2D and 3D imaging assets as described herein). Such digital objects or assets can represent a real-world physical parts, assemblies(s), or documents, customer requirements or supplier parts, a change process, and/or other data types relating to a lifecycle management and development of a product and/or package. For example, digital objects or assets can include computer-aided design (CAD) file(s) that depict or describe (e.g., via measurements, sizes, etc.) parts, components, or complete (or partially complete) models or designs of products and/or packages. Generally, non-CAD files can also be included in database 105. Such non-CAD files can include text or data files describing or defining parts, components, and/or product or package specifications, vendor datasheets, or emails relating to a design. For example, a PLM database or system can index and access text contents of a file, which can include metadata or other information regarding a product or package for design purposes.

In addition, PLM objects or assets, and/or corresponding data records, such as those that may be stored in database 105, can contain properties regarding an object's or an asset's parameters or aspects of its design lifecycle. For example, PLM database or systems can generally store different classes of objects or assets (primarily parts (e.g., as CAD files), documents, and change forms) with distinct properties and behaviors. Such properties can include metrics or metadata such as part/document number, item category, revision, title, unit of measure, bill of materials, cost, mass, regulatory compliance details, file attachments, and other such information regarding product(s), and/or package(s) of a company. In addition, such PLM objects or assets may be linked, e.g., within database 105 (e.g., as a relational database), to other objects or assets within database 105 for the association of or otherwise generation or construction of a product structure. In this way, a PLM database can be flexibly used to identify objects and assets, create and define relationships among such objects and assets. Such flexibility provides a basis for the creation, customization, revision, and/or reuse of virtual models (e.g., virtual 3D models) as described herein, and also the 2D imaging assets on which they are based.

For example, in some aspects, processor(s) 104 may store virtual 3D model(s) in memory 106 and/or database 105 such that virtual 3D model(s) are accessible to an imaging asset manipulation script or a visualization editor. In this way, an imaging asset manipulation script or the visualization editor, in a new or next iteration of a product lifecycle or introduction of new product lifecycle, may generate one or more new or additional virtual 3D models corresponding to one or more new or additional real-world products or product packages, or one or more new or additional virtual 3D models corresponding to updated versions of existing real-world products or product packages.

In various aspects described herein, database 105, implemented as a PLM database or system, can support CAD files for components or parts of existing or future (i.e., to be designed) products and/or packages. Such a PLM database or system can be implemented, for example, via third party software such as ALTIUM DESIGNER, ORCAD component information system (CIS), or the like.

While a PLM based database and system are described in various aspects herein, it is to be understood that other database or memory management systems (e.g., standard relational databases, NoSQL databases, etc.) may likewise be used in accordance with the disclosure of the 3D modeling systems and methods herein. As a non-limiting example, a PLM based database and/or system may comprise a “data lake” or the like, where a data lake or similar such database can comprise a system or repository of data stored in its natural/raw format, for example, as object blobs, raw bytes, and/or data files.

Further, with respect to FIG. 1, server(s) 102 may further include a communication component configured to communicate (e.g., send and receive) data via one or more external/network port(s) to one or more networks or local terminals, such as computer network 120 and/or terminal 109 (for rendering or visualizing) as described herein. In some aspects, server(s) 102 may include a client-server platform technology such as ASP.NET, Java J2EE, Ruby on Rails, Node.js, Flask, or other web service or online API, responsive for receiving and responding to electronic requests. The server(s) 102 may implement the client-server platform technology that may interact, via the computer bus, with memories(s) 106 (including the applications(s), component(s), API(s), data, etc. stored therein) and/or database 105 to implement or perform the machine readable instructions, methods, processes, elements or limitations, as illustrated, depicted, or described for the various flowcharts, illustrations, diagrams, figures, and/or other disclosure herein. According to some aspects, the server(s) 102 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to computer network 120.

Server(s) 102, via processor(s) 104, may further include, implement, or launch a visualization editor, or otherwise operator interface, to render models or photorealistic images, present information to a user, and/or receive inputs or selections from the user. As shown in FIG. 1, the user interface may provide a display screen or graphic display (e.g., via terminal 109).

Server(s) 102 may also provide I/O components (e.g., ports, capacitive or resistive touch sensitive input panels, keys, buttons, lights, LEDs), which may be directly accessible via or attached to server(s) 102 or may be indirectly accessible via or attached to terminal 109. According to some aspects, a user may access the server 102 via terminal 109 to render models or photorealistic images (e.g., via a visualization editor), review information, make changes, input data, and/or perform other functions.

As described above herein, in some aspects, server(s) 102 may perform the functionalities as discussed herein as part of a “cloud” network or may otherwise communicate with other hardware or software components within the cloud to send, retrieve, or otherwise analyze data or information (e.g., virtual 3D model(s)) as described herein.

In various aspects herein, a computer program, script, code, or application, (e.g., an imaging asset manipulation script) may comprise computer-readable program code or computer instructions, in accordance with aspects herein, and may be stored on a computer usable storage medium, or tangible, non-transitory computer-readable medium (e.g., standard random access memory (RAM), an optical disc, a universal serial bus (USB) drive, or the like). Such comprise computer-readable program code or computer instructions may be installed on or otherwise adapted to be executed by processor(s) 104 (e.g., working in connection with the respective operating system in memories 106) to facilitate, implement, or perform the machine readable instructions, methods, processes, elements or limitations, as illustrated, depicted, or described for the various flowcharts, illustrations, diagrams, figures, and/or other disclosure herein. In this regard, the program code or scripts may be implemented in any desired program language, and may be implemented as machine code, assembly code, byte code, and/or interpretable source code or the like (e.g., via Golang, Python, C, C++, C#, Objective-C, Java, Scala, ActionScript, JavaScript, HTML, CSS, XML, etc.). For example, as described herein, server(s) 102, implementing processor(s) 104, may execute one or more imaging asset manipulation scripts to assemble or otherwise manipulate or generate parametric-based CAD models or other models described herein.

In the example aspect of FIG. 1, modeling server(s) 102 are communicatively connected, via computer network 120. Computer network 120 may comprise a packet based network operable to transmit computer data packets among the various devices and servers described herein. For example, computer network 120 may consist of any one or more of Ethernet based network, a private network, a local area network (LAN), and/or a wide area network (WAN), such as the Internet.

For example, as shown for FIG. 1, computer network 120 connects and extends 3D modeling system 100, where virtual 3D model(s) may be transmitted to third-party server(s) 150 of third-parties (e.g., such as retailers or customers) at remote locations 152 for creation or review of real-world product(s) and/or product packages as described herein. In such aspects, server(s) 102 and/or processor(s) 104 may be configured to initiate creation of at least a portion of a real-world product or product package based on a virtual 3D model, as described herein. For example, in some aspects, a virtual 3D model may be transmitted to a 3D printer for creation of at least a portion of the real-world product or product package. For example, either local 3D printer 107 or remote 3D printer 157 (e.g., via computer network 120) may receive a virtual 3D model for printing of a corresponding real-world product and/or product package (or portion thereof). In such aspects, a 3D printer may load, or otherwise analyze, a virtual 3D model as described herein, causing the 3D printer to print or produce the corresponding real-world product or product package (or portion thereof).

In some aspects, modeling server(s) 102 may download or retrieve 2D imaging assets over computer network 120. For example, 2D imaging assets may be downloaded, by modeling server(s) 102, from remote server(s) 140 which may store 2D imaging assets. Remote server(s) 140 may be those of a third-party or of the company designing or developing product(s) and/or product package(s) as described herein. In some aspects, a portion or subset of 2D imaging assets and/or dimensional data required to design product(s) and/or product package(s) may be retrieved from the remote server(s) 140.

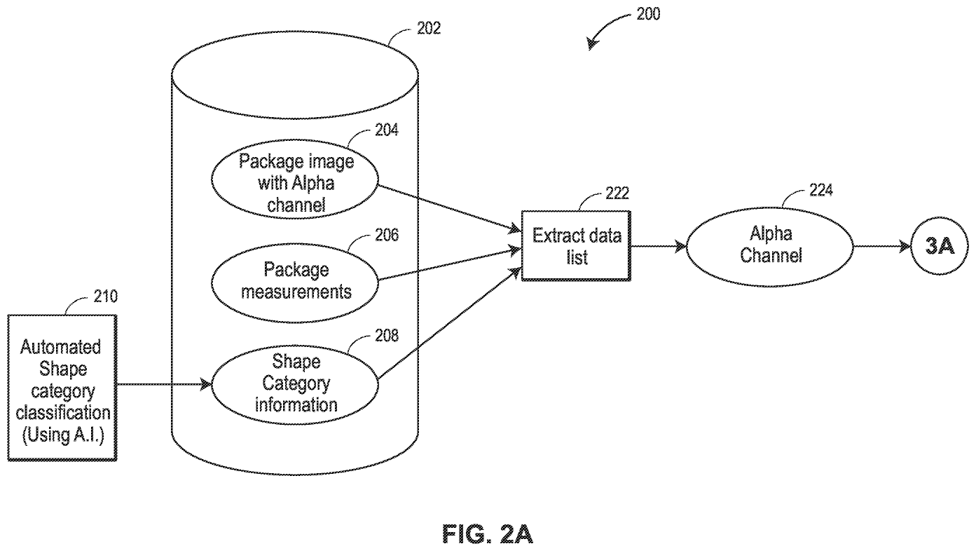

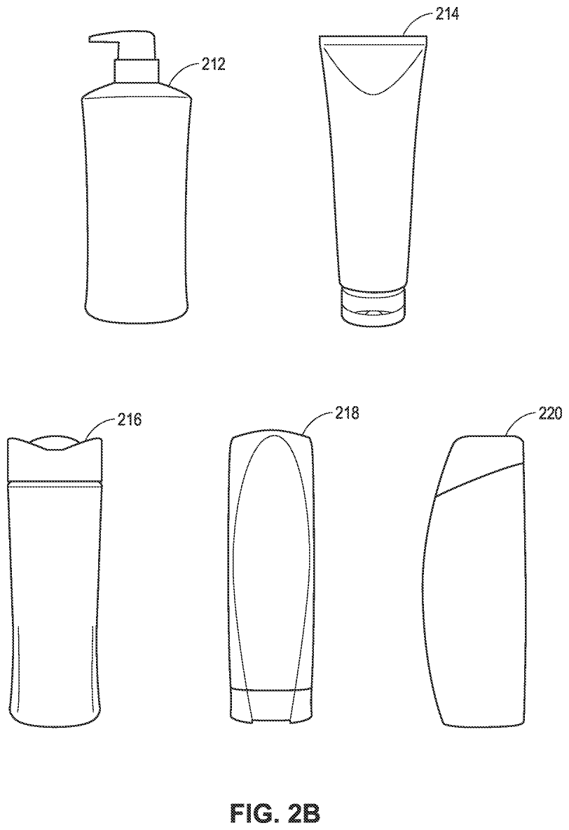

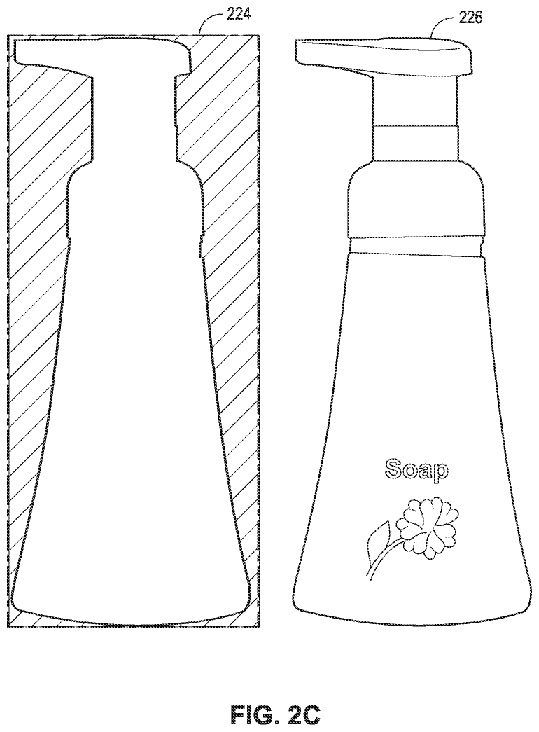

FIG. 2A illustrates a flow diagram 200 depicting a memory (e.g., database 202) configured to store 2D imaging asset(s), dimensional dataset(s), and/or shape classification dataset(s) (e.g., assets/datasets 204, 206, 208), or links or references to such assets or datasets, accessible by the one or more processors and the computing instructions of the imaging asset manipulation script 108, as described for the 3D modeling system of FIG. 1, in accordance with various aspects disclosed herein. In the aspect of FIG. 2, database 202 corresponds to database 105 and/or memory 106, and related disclosure, as described for FIG. 1.

In the aspect of FIG. 2A, shape category classifications 208 associated with various respective real-world products or product packages may be determined (210), e.g., by the imaging asset manipulation script 108. In some examples, these shape category classifications 208 may be determined automatically, e.g., using machine learning or other artificial intelligence (AI) methods to analyze various 2D imaging asset(s) 204 and/or respective alpha channels 224 associated with respective real-world products or product packages to determine the shape category classifications 208 corresponding to each respective product or product package. Additionally, in some examples, shape category classifications 208 may be determined based on input from a user indicating shape category classifications 208 for various real-world product or product packages. For instance, possible shape category classifications 208 may include a bottle classification, a symmetrical pump classification, a tube classification, a symmetrical bottle classification, a tottle classification, an asymmetrical bottle classification, a box classification, a pouch classification, a bag classification, a handled bottle classification, and/or a blister pack classification, or any other suitable shape classifications. FIG. 2B illustrates a visualization or rendering of several possible shape category classifications 208, such as a symmetrical pump classification 212, a tube classification 214, a symmetrical bottle classification 216, a tottle classification 218, and an asymmetrical bottle classification 220, in accordance with various aspects disclosed herein. Referring back to FIG. 2A, in any case, the shape classifications 208 for various real-world products or product packages may be stored in the database 202. Additional shape category classifications 208 may include, a handled bottle classification, a no nozzle pump bottle classification, a nozzle pump bottle classification, a trigger bottle classification, a symmetric can classification, a carton classification, a round jar classification, an asymmetrical tottle classification, a symmetrical tottle classification, a tub classification, a cylindrical tub classification, a symmetrical tub classification, etc.

As shown at FIG. 2A, assets/datasets corresponding to a particular real-world product or product package to be virtually modeled in 3D space may be extracted (222) from the database 202, e.g., by the imaging asset manipulation script 108. For instance, a shape category classification 208 defining a real-world product or product package to be virtually modeled in 3D space may be obtained or extracted 222 from the database 202, e.g., by the imaging asset manipulation script 108. Additionally, a dimensional dataset 206 defining product or package measurements of the same real-world product or product package may be obtained or extracted 222 from the database 202, e.g., by the imaging asset manipulation script 108. Furthermore, a 2D imaging asset 204 (e.g., a 2D digital image) depicting the real-world product or product package may be obtained, selected, or otherwise extracted 222 from the database 202, e.g., by the imaging asset manipulation script 108. Obtaining, selecting, or extracting 222 the 2D imaging asset 204 depicting the real-world product or product package may include obtaining, selecting, or extracting 222 an alpha channel 224 (also called an “image alpha” or “image alpha channel” in some cases) from the 2D imaging asset 204, e.g., by the imaging asset manipulation script 108. FIG. 2C illustrates a visualization or rendering of an example alpha channel 224 and a 2D imaging asset 226 from which the alpha channel 224 may be extracted, depicting a real-world product or product package, as described by the flow diagram of FIG. 2A.

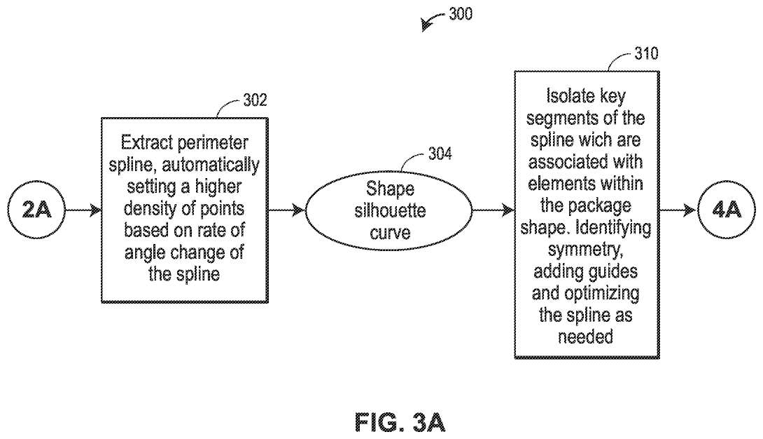

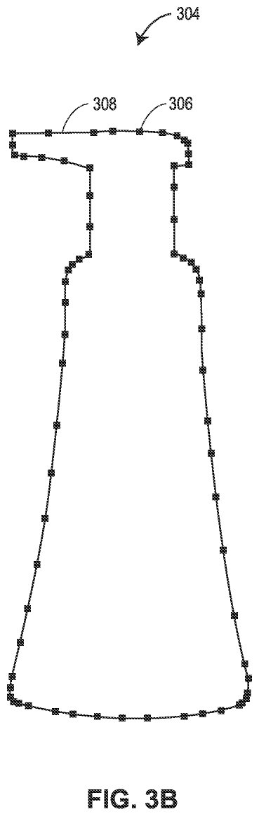

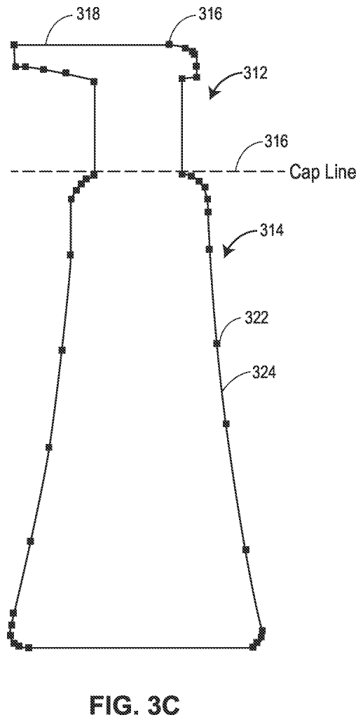

FIG. 3A illustrates a flow diagram 300 of an example imaging asset manipulation script 108 for generating a spline, based on an alpha channel extracted from a 2D imaging asset depicting a real-world product or product package, such as the alpha channel of FIG. 2C, in accordance with various aspects disclosed herein. In the aspect of FIG. 3A, the imaging asset manipulation script 108 may generate a spline, based on an alpha channel, such as the alpha channel 224. For instance, the imaging asset manipulation script 108 may extract (302) a perimeter spline 304 from the alpha channel 224. Specifically, an alpha channel 224 of a 2D product image may be used to make the background of the image transparent, and in the alpha channel 224, the pixels with color (i.e., as opposed to transparent pixels) are identified to define the spline. The spline 304 may represent the curve of the shape silhouette of the alpha channel 224. In some examples, the model is automatically cleaned, depending on the quality of the spline 304 that is created. Additionally, in some examples, users may adjust factors such as the decimation angle and the opacity point of the edge of the original 2D image from which the alpha channel 224 is extracted, and from which the spline 304 is generated, in order to produce a higher quality spline.

FIG. 3B illustrates a visualization or rendering of a spline 304 generated based on an alpha channel 224 extracted from a 2D imaging asset 226 depicting a real-world product or product package, as described by the flow diagram of FIG. 3A, in accordance with various aspects disclosed herein. That is, generally speaking, the spline 304 may include a plurality of points 306 positioned along a perimeter 308 of the shape silhouette of the alpha channel 224 (shown at FIG. 2C). For instance, the imaging asset manipulation script 108 may adjust the spline 304 to optimize the mapping of the spline 304 to the alpha channel 224, for instance, by identifying asymmetry, adding guides, and optimizing the spline 304 as needed. Moreover, the imaging asset manipulation script 108 may adjust the data size of the spline 304, i.e., by reducing or adjusting one or more of the plurality of points 306 positioned along the perimeter 308 of the alpha channel 224. That is, some instances, after this adjustment, the spline 304 may have a varying density of points 306 based on the rate of angle change of the spline 304, such that portions of the spline with a high rate of angle change and/or curvature and/or angle threshold have more points 306, while portions of the spline 304 with a comparatively lower rate of angle change and/or curvature and/or angle threshold have fewer points 306. Accordingly, reducing the number of points 306 for portions of the spline 304 with a comparatively lower rate of angle change may reduce the total number of points 306, which reduces the data size of the spline 304.

In some examples, the imaging asset manipulation script 108 may additionally isolate (310) segments of the spline 304 that are associated with particular elements within the shape of the real-world product or product package to be virtually modeled in 3D space. For instance, FIG. 3C illustrates a visualization or rendering of a spline 304 generated based on an alpha channel 224 extracted from a 2D imaging asset 226 depicting a real-world product or product package, with key segments associated with elements within the shape of the real-world product or product package isolated. As shown in FIG. 3C, for instance, multiple splines may be generated using the same alpha channel 224, in some examples. That is, the dimensional dataset 206 of the real-world product or product package may include additional sub-datasets for various portions of the real-world product or product package, such as a first sub-dataset for a cap portion of the real-world product or product package, and a second sub-dataset for a bottle portion of the real-world product or product package. For instance, a first spline 312 for a cap portion of the real-world product or product package and a second spline 314 for a bottle portion of the real-world product or product package may both be generated using the same alpha channel 224. The first spline 312 may include points 316 positioned along a perimeter 318 of a first portion (i.e., the cap portion) of the alpha channel 224, corresponding to the first portion (i.e., the cap portion) of the real-world product or product package. The second spline 314 may include points 320 positioned along a perimeter 322 of second first portion (i.e., the bottle portion) of the alpha channel 224, corresponding to the second portion (i.e., the bottle portion) of the real-world product or product package.

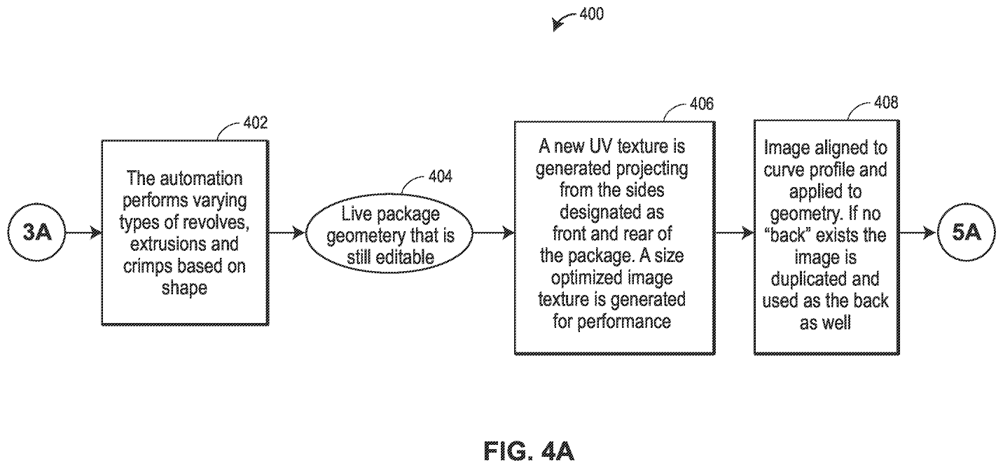

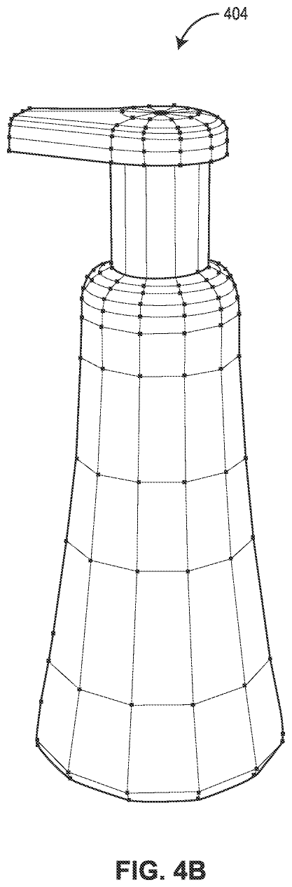

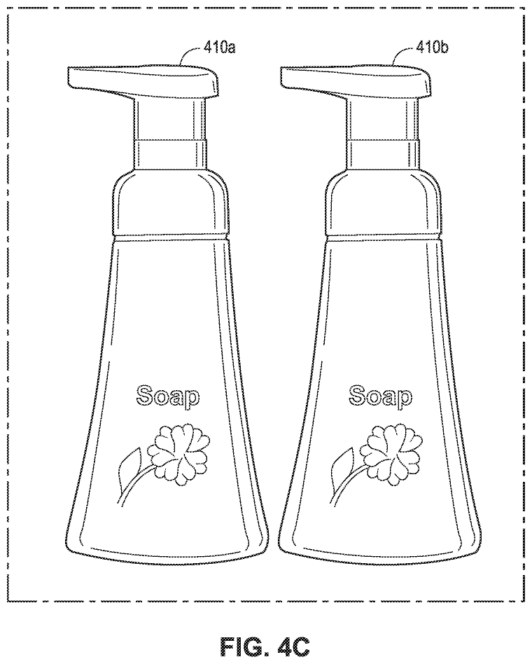

FIG. 4A illustrates a flow diagram 400 of an example imaging asset manipulation script 108 for generating a parametric model based on the spline 304, the dimensional dataset 206, and the shape category classification 208 for the real-world product or product package and generating a virtual 3D model of the real-world product or product package based on the parametric model and one or more attributes corresponding to the real-world product or product package, in accordance with various aspects disclosed herein. For instance, the imaging asset manipulation script 108 may perform (402) various types of revolves, extrusions, and crimps based on the shape of the spline 304 in order to generate the parametric model 404. In particular, the parametric model 404 may include live package geometry 502 that is still editable. FIG. 4B illustrates a visualization or rendering of a parametric model 404 generated based on the spline 304, the dimensional dataset 206, and the shape category classification 208 for the real-world product or product package, as described by the flow diagram of FIG. 4A, in accordance with various aspects disclosed herein.

Referring back to FIG. 4A, the flow diagram 400 may further include generating, e.g., by the imaging asset manipulation script 108, a virtual 3D model 410 of the real-world product or product package based on the parametric model 404, e.g., as shown at FIG. 4B, and one or more attributes corresponding to the real-world product or product package. For instance, these attributes may include a UV texture map, which may be generated (406) e.g., by the imaging asset manipulation script 108, to define at least one of: a front graphical representation or a rear graphical representation of the real-world product or product package. Moreover, a size-optimized image texture may be generated, e.g., by the imaging asset manipulation script 108, for performance. Furthermore, the 2D imaging asset 204 depicting the real-world product or product package may be aligned to the curve profile of the parametric model 404, and may be applied (408), e.g., by the imaging asset manipulation script 108, to the geometry of the parametric model 404.

In some examples, separate UV texture maps corresponding to various sides or views of the real-world product or product package (e.g., a front graphical representation, a rear graphical representation, various side graphical representations, a top graphical representation, a bottom graphical representation, etc.) of the real-world product or product package may be respectively applied to the respective portions (e.g., a front portion, a rear portion, various side portions, a top portion, a bottom portion, etc.) of the parametric model 404. In other words, each of the graphical representations of each side or view may be generated as a different graphical representation for rendering as a virtual UV texture of the real-world product or product package. Additionally, in some examples, if only a UV texture map for only one side or representation (e.g., a front graphical representation) of the real-world product or product package is available, the UV texture map for the front graphical representation of the real-world product or product package may be duplicated and applied (408) to multiple portions of the parametric model 404. In other words, each of the front graphical representation and the rear graphical representation may be generated as the same graphical representation for rendering as a virtual front UV texture and a virtual back UV texture of the virtual 3D model 410 of the real-world product or product package, i.e., based on the availability of graphical representations of the front or rear of the real-world product or product package.

For instance, FIG. 4C illustrates a visualization or rendering of a virtual 3D model 410 of a real-world product or product package generated based on a parametric model generated based on a spline, a dimensional dataset, and a shape classification for a real-world product or product package, and one or more attributes corresponding to the real-world product or product package, as described by the flow diagram of FIG. 4A, in accordance with various aspects disclosed herein. The virtual 3D model 410 may be a high fidelity polygonal model representation of the real-world product or product package.

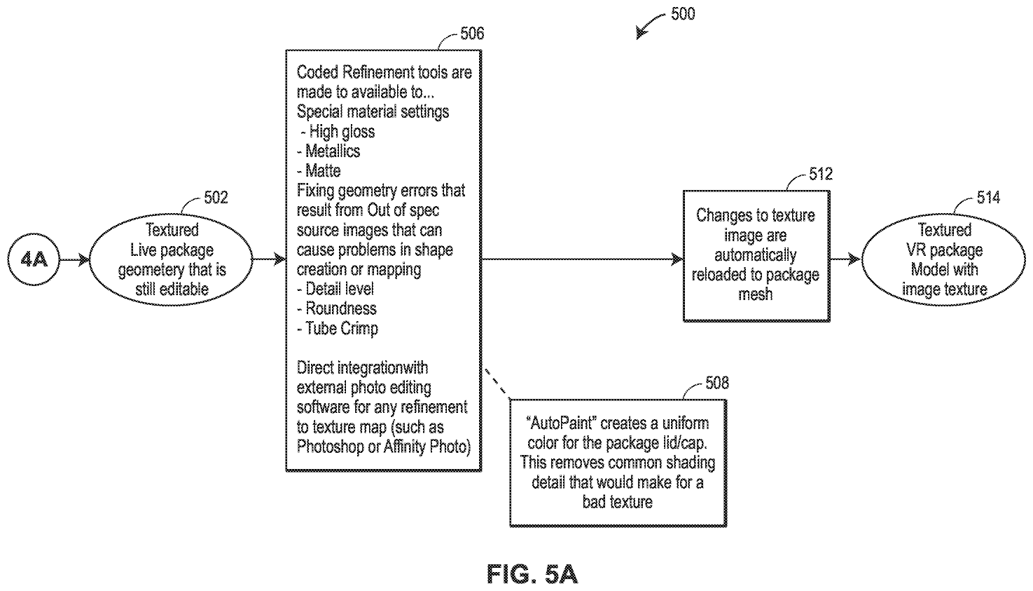

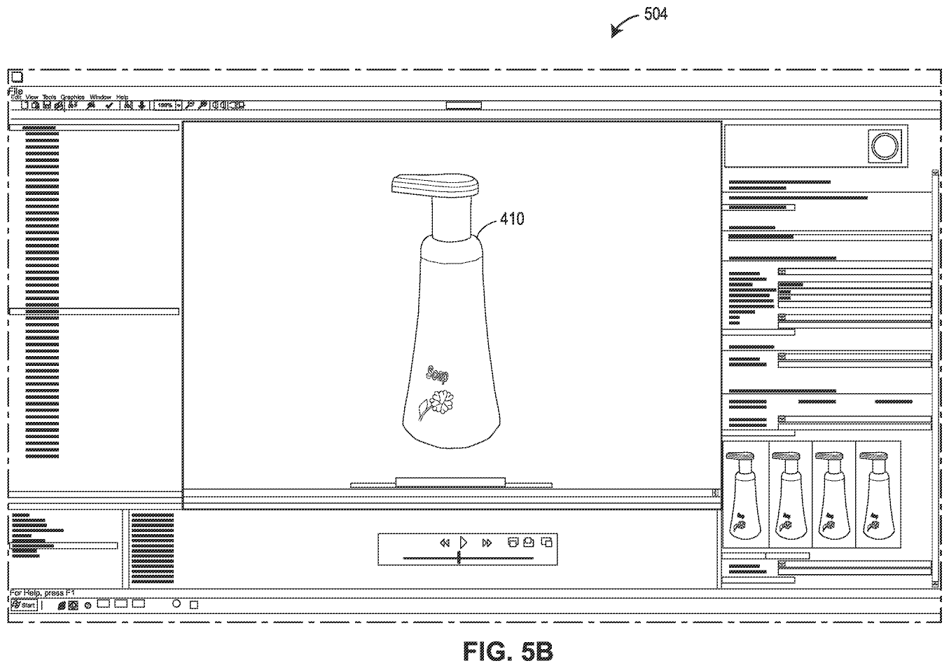

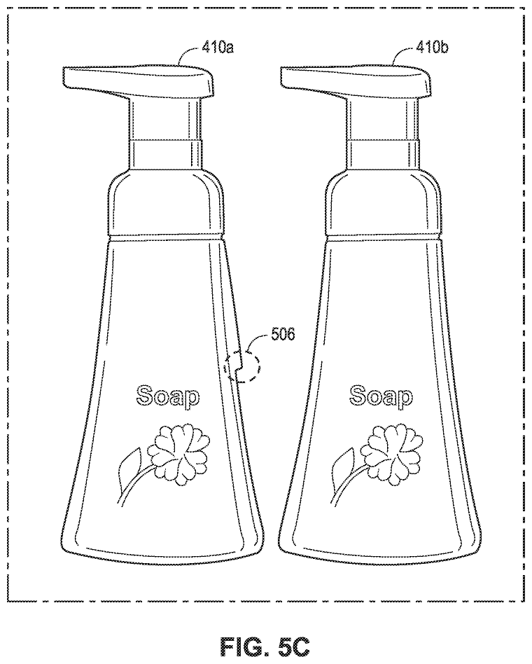

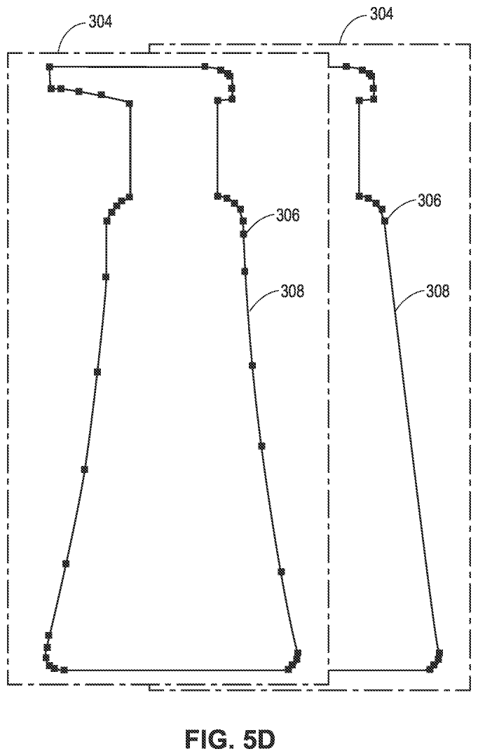

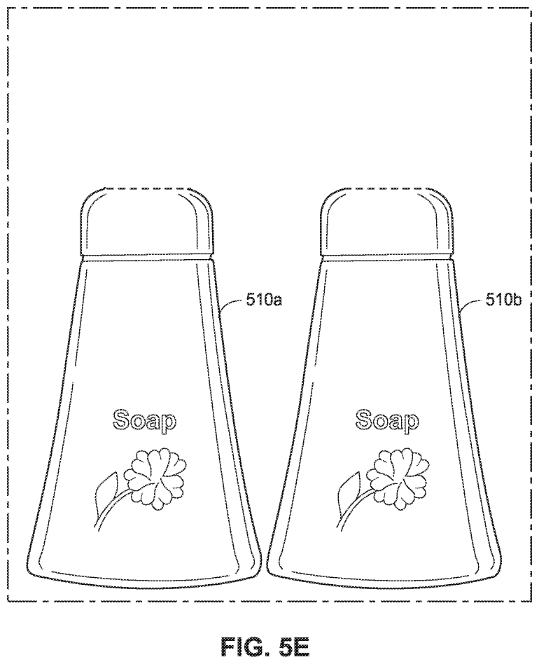

FIG. 5A illustrates a flow diagram 500 of an example imaging asset manipulation script 108 and/or a visualization editor for refining a virtual 3D model 410 of a real-world product or product package generated based on the parametric model 404 e.g., as shown at FIG. 4C, in accordance with various aspects disclosed herein. For example, the virtual 3D model 410 may include textured live package geometry 502 that is still editable, e.g., by the imaging asset manipulation script 108, and/or by a visualization editor. In some examples, the image asset manipulation script 108 may be configured to launch a graphical user interface (GUI), the GUI configured to load into memory, or render on the graphical display, any one or more of the 2D imaging assets, the dimensional datasets, the spline, the parametric model, or the virtual 3D model.

For instance, FIG. 5B illustrates an example GUI for an example visualization editor 504, through which a user may adjust or refine the one or more image features associated with the virtual 3D model 410 of a real-world product or product package (e.g., any one or more of the 2D imaging assets 204, the dimensional datasets 206, the spline 304, the parametric model 404, the virtual 3D model 410, the live package geometry 502, etc.). The GUI may be configured to receive user selections to manipulate any one or more of the 2D imaging assets 204, the dimensional datasets 206, the spline 304, the parametric model 404, the virtual 3D model 410, the live package geometry 502, etc. For instance, the visualization editor 504 may be ADOBE® PHOTOSHOP®, or AFFINITY®, or any other suitable visualization editor 504 for editing textures as described herein, which may receive adjustment or application commands, via a GUI, to update the virtual 3D model 410 or any of the 2D imaging assets 204, the dimensional datasets 206, the spline 304, the parametric model 404, the virtual 3D model 410, the live package geometry 502, etc., associated therewith. For instance, the visualization editor 504 may generate or render a new virtual 3D model 410 based on the user selections via the GUI. That is, the new virtual 3D model 410 may represent an updated product or product package corresponding to the user selections. The image asset manipulation script 108 and/or visualization editor 504 may store the virtual 3D model 410 in a memory such that the virtual 3D model 410 is accessible to the imaging asset manipulation script 108 or the visualization editor 504 at a later time, i.e., for additional refinement.

Referring back to FIG. 5A, refining (506) the virtual 3D model 410 may include refining material or texture settings associated with the textured live package geometry 502, such as a high gloss texture, a metallic texture, or a matte texture, e.g., by the imaging asset manipulation script 108 and/or the visualization editor 504. Moreover, refining (506) the virtual 3D model 410 may include fixing geometry errors (e.g., resulting from source images) that can cause problems in shape creation or mapping, e.g., by adjusting the detail level, roundness, and/or tube crimp of any of the spline 304, the parametric model 404, and/or the textured live package geometry 502, e.g., by the imaging asset manipulation script 108 and/or a visualization editor 504.

For example, FIG. 5C illustrates a visualization or rendering of an example adjustment or refinement as may be applied to the textured live package geometry 502 associated with the virtual 3D model 410. For instance, an edge 506 of the textured live package geometry 502 associated with the virtual 3D model 410 may be “cleaned up,” as shown at FIG. 5C. In other examples, for instance, colors may be adjusted, e.g., to make white lettering more white or to make dark lettering darker. The example adjustment or refinement may be performed manually by a user via the visualization editor 504, or automatically by the imaging asset manipulation script 108. For instance, the imaging asset manipulation script 108 may automatically identify text of the textured live package geometry 502 associated with the virtual 3D model 410, determine the current pixel value associated with the text as being close to white, and increase the pixel value closer to 255 (white). As another example, the imaging asset manipulation script 108 may automatically modify the lighting or shadow of the textured live package geometry 502 associated with the virtual 3D model 410 for better visibility.

FIG. 5D illustrates a visualization or rendering of another example adjustment or refinement as may be applied to the textured live package geometry 502 associated with the virtual 3D model 410, e.g., by the imaging asset manipulation script 108 and/or a visualization editor 504. For instance, as shown at FIG. 5D, the textured live package geometry 502 associated with the virtual 3D model 410 may be edited based on receiving a selection or drag command to adjust or reduce the one or more points 306 of the spline 304 or the parametric model 404 via the visualization editor 504, in order to rebuild the mesh of the parametric model 404 upon which the virtual 3D model 410 is based and generate an updated virtual 3D model 410.

The flow diagram 500 may further include, in some cases, adjusting or refining the virtual 3D model 410 by “autopainting” (508), i.e., applying textures or refinements to, different portions of the textured live package geometry 502 associated with the virtual 3D model 410 differently, e.g., by the imaging asset manipulation script 108 and/or a visualization editor 504. As one example, a first graphical texture or a first color may be added or applied (508) to a first portion of the real-world product or product package to be virtually modeled in 3D space, while a second, different, graphical texture or a second color is added or applied (508) to the second portion of the real-world product or product package to be virtually modeled in 3D space. For instance, certain textures or other refinements may applied (508) to a portion of the textured live package geometry 502 corresponding to the “cap” portion 312 of the spline 304, e.g., as shown at FIG. 3C, while other textures or other refinements may be applied (508) to the portion of the textured live package geometry 502 corresponding to the “bottle” portion 314 of the spline 304, as shown at FIG. 3C. For example, FIG. 5E illustrates an example of applying particular textures or refinements to only the portion 510 of the textured live package geometry 502 corresponding to the “bottle” portion 314 of the spline 304, and not to the portion of the textured live package geometry 502 corresponding to the “cap” portion 312 of the spline 304. Of course, in other examples, the same graphical textures and/or colors may be added or applied (508) to multiple or all portions of the textured live package geometry 502, i.e., the same graphical textures and/or colors may be added or applied (508) to both the portion of the textured live package geometry 502 corresponding to the “cap” portion 312 of the spline 304 and the portion 510 of the textured live package geometry 502 corresponding to the “bottle” portion 314 of the spline 304.

Additionally, the flow diagram 500 may further include automatically reloading, e.g., by the imaging asset manipulation script 108, any changes to be made to the editable textured live package geometry 502 of the virtual 3D model 410, in order to produce a textured virtual reality package model with updated image textures 514. The imaging asset manipulation script 108 may render the textured virtual reality package model with updated image textures 514 in virtual 3D space, e.g., as part of a mixed reality environment, such as an augmented reality (AR) environment.

In some examples, the imaging asset manipulation script 108 may further initiate the creation of at least a portion of the real-world product or product package based on the virtual 3D model. For instance, the imaging asset manipulation script 108 may cause or initiate the creation of at least a portion of the real-world product or product package based on the virtual 3D model using a 3D printer.

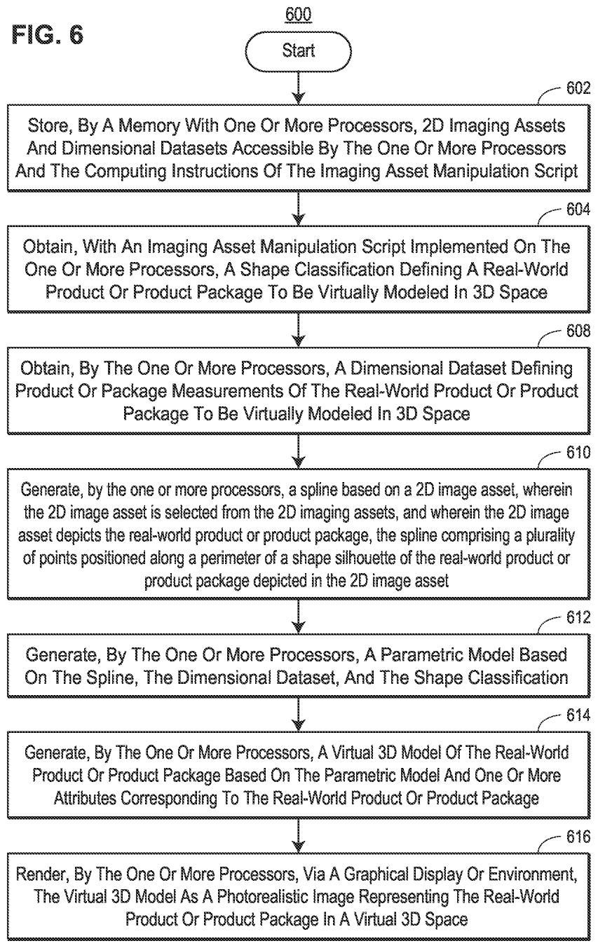

FIG. 6 illustrates a flow diagram or algorithm of an example 3D modeling method 600 for automatically generating photorealistic, virtual 3D package and product models from two-dimensional (2D) imaging assets and dimensional data, in accordance with various aspects disclosed herein. It is to be understood that the flow diagram of FIG. 6 illustrates an imaging asset manipulation script (e.g., such as imaging asset manipulation script 108) comprising computing instructions or an algorithm for automatically generating photorealistic, virtual 3D package and product models from two-dimensional (2D) imaging assets and dimensional data, as described, for example, by the various Figures herein, including FIGS. 1, 2A-2C, 3A-3C, 4A-4C, and 5A-5E.

At block 602, 3D modeling method 600 includes storing, by a memory (e.g., memorie(s) 106 and/or database 105) with one or more processors (e.g., processor(s) 104), one or more 2D imaging assets (e.g., 2D imaging asset(s) 204) and dimensional datasets (e.g., dimensional dataset(s) 206) accessible by the one or more processors and the computing instructions of an imaging asset manipulation script (e.g., imaging asset manipulation script 108).

At block 604, 3D modeling method 600 further includes obtaining, with the imaging asset manipulation script (e.g., imaging asset manipulation script 108) implemented on the one or more processors (e.g., processor(s) 104), a shape classification (e.g., shape classification 208) defining a real-world product or product package to be virtually modeled in 3D space.

At block 608, 3D modeling method 600 further includes obtaining, with the imaging asset manipulation script (e.g., imaging asset manipulation script 108) implemented on the one or more processors (e.g., processor(s) 104), a dimensional dataset (e.g., of the dimensional dataset(s) 206) defining product or package measurements of the real-world product or product package to be virtually modeled in 3D space.

At block 610, 3D modeling method 600 further includes generating, with the imaging asset manipulation script (e.g., imaging asset manipulation script 108) implemented on the one or more processors (e.g., processor(s) 104), a spline (e.g., spline 304), based on a 2D image asset, wherein the 2D image asset is selected from the 2D imaging assets (e.g., 2D imaging asset(s) 204), and wherein the 2D image asset depicts the real-world product or product package, the spline comprising a plurality of points (e.g., points 306) positioned along a perimeter (e.g., perimeter 308) of a shape silhouette of the real-world product or product package depicted in the 2D image asset.

At block 612, 3D modeling method 600 further includes generating, with the imaging asset manipulation script (e.g., imaging asset manipulation script 108) implemented on the one or more processors (e.g., processor(s) 104), a parametric model (e.g., parametric model 404) based on the spline (e.g., spline 304), the dimensional dataset (e.g., dimensional dataset 206), and the shape classification (e.g., shape classification 208).

At block 614, 3D modeling method 600 further includes generating, with the imaging asset manipulation script (e.g., imaging asset manipulation script 108) implemented on the one or more processors (e.g., processor(s) 104), a virtual 3D model (e.g., virtual 3D model 410) of the real-world product or product package based on the parametric model (e.g., parametric model 404) and one or more attributes corresponding to the real-world product or product package.

At block 616, 3D modeling method 600 further includes rendering, via a graphical display or environment (e.g., via terminal 109), the virtual 3D model as a photorealistic image representing the real-world product or product package in a virtual 3D space.

Aspects of the Disclosure

1. A three-dimensional (3D) image modeling system configured to automatically generate photorealistic, virtual 3D package and product models from two-dimensional (2D) imaging assets and dimensional data, the 3D image modeling system comprising: one or more processors; an imaging asset manipulation script comprising computing instructions configured to execute on the one or more processors; and a memory configured to store 2D imaging assets and dimensional datasets accessible by the one or more processors and the computing instructions of the imaging asset manipulation script, wherein the computing instructions of the imaging asset manipulation script, when executed by the one or more processors, cause the one or more processors to: obtain a shape classification defining a real-world product or product package to be virtually modeled in 3D space, obtain a dimensional dataset defining product or package measurements of the real-world product or product package to be virtually modeled in 3D space, generate a spline, based on a 2D image asset, wherein the 2D image asset is selected from the 2D imaging assets, and wherein the 2D image asset depicts the real-world product or product package, the spline comprising a plurality of points positioned along a perimeter of a shape silhouette of the real-world product or product package depicted in the 2D image asset, generate a parametric model based on the spline, the dimensional dataset, and the shape classification, generate a virtual 3D model of the real-world product or product package based on the parametric model and one or more attributes corresponding to the real-world product or product package, and render, via a graphical display or environment, the virtual 3D model as a photorealistic image representing the real-world product or product package in a virtual 3D space.

2. The 3D image modeling system of aspect 1, wherein the shape classification comprises at least one of: a bottle classification, a symmetrical pump classification, a tube classification, a symmetrical bottle classification, a tottle classification, an asymmetrical bottle classification, a box classification, a pouch classification, a bag classification, a handled bottle classification, or a blister pack classification.

3. The 3D image modeling system of any one of aspects 1-2, wherein the computing instructions of the imaging asset manipulation script, when executed by the one or more processors, cause the one or more processors to: adjust the spline to optimize the mapping of the spline to the alpha channel or reduce the data size the spline by reducing or adjusting one or more of the plurality of points positioned along the perimeter of the alpha channel.

4. The 3D image modeling system of any one of aspects 1-3, wherein the computing instructions of the imaging asset manipulation script, when executed by the one or more processors, cause the one or more processors to: generate, based on the 2D image asset, a UV graphical texture defining at least one of: a first graphical representation or a second graphical representation of the real-world product or product package.

5. The 3D image modeling system of aspect 4, wherein each of the first graphical representation and the second graphical representation are generated as a different graphical representation or a same graphical representation for rendering as a virtual first side UV texture and a virtual second side UV texture of the virtual 3D model of the real-world product or product package.

6. The 3D image modeling system of any one of aspects 1-5, wherein the spline is a first spline, comprising a plurality of points positioned along a perimeter of a first shape silhouette of a first portion of the real-world product or product package depicted in the 2D image asset, and wherein the computing instructions of the imaging asset manipulation script, when executed by the one or more processors, cause the one or more processors to: generate a second spline comprising a plurality of points positioned along a perimeter of a second shape silhouette of the second portion of the real-world product or product package depicted in the 2D image asset.

7. The 3D image modeling system of aspect 6, wherein the computing instructions of the imaging asset manipulation script, when executed by the one or more processors, cause the one or more processors to: add a first graphical texture or a first color to the first portion of the real-world product or product package to be virtually modeled in 3D space; add a second graphical texture or a second color to the second portion of the real-world product or product package to be virtually modeled in 3D space, the second graphical texture or the second color being different from the first graphical texture or the first color.

8. The 3D image modeling system of aspect 6, wherein the computing instructions of the imaging asset manipulation script, when executed by the one or more processors, cause the one or more processors to: add a first graphical texture or a first color to the first portion of the real-world product or product package to be virtually modeled in 3D space; add a second graphical texture or a second color to the second portion of the real-world product or product package to be virtually modeled in 3D space, the second graphical texture or the second color being consistent the first graphical texture or the first color.

9. The 3D image modeling system of any one of aspects 1-8, wherein the computing instructions of the imaging asset manipulation script, when executed by the one or more processors, cause the one or more processors to: update the spline or the parametric model by applying one or more refinements.

10. The 3D image modeling system of aspect 9, wherein one or more points of the spline or the parametric model are configured to be selected or dragged, and wherein the one or imaging refinements comprise receiving a selection or drag command to adjust or reduce the one or more points of the spline or the parametric model.

11. The 3D image modeling system of any one of aspects 8-9, wherein one or more image features are configured to be adjusted for or applied to the virtual 3D model, and wherein the one or refinements comprise receiving an adjustment or application command to update the virtual 3D model.

12. The 3D image modeling system of any one of aspects 1-11, wherein the virtual 3D model is a high fidelity polygonal model representation of the real-world product or product package.

13. The 3D image modeling system of any one of aspects 1-12, wherein the computing instructions of the imaging asset manipulation script, when executed by the one or more processors, cause the one or more processors to: initiate creation of at least a portion of the real-world product or product package based on the virtual 3D model.

14. The 3D image modeling system of aspect 13, wherein the computing instructions of the imaging asset manipulation script, when executed by the one or more processors, cause the one or more processors to: create, with a 3D printer, at least a portion of the real-world product or product package based on the virtual 3D model.

15. The 3D image modeling system of aspect 12, wherein the high fidelity polygonal model is rendered in the virtual 3D space as part of a mixed reality environment.

16. The 3D image modeling system of any one of aspects 1-15, further comprising a server comprising at least one processor of the one or more processors, wherein at least a portion of 2D imaging assets and dimensional datasets are retrieved via a computing network.

17. The 3D image modeling system of any one of aspects 1-16, wherein the one or more processors are further configured to launch a graphical user interface (GUI), the GUI configured to load into memory, or render on the graphical display, any one or more of the 2D imaging assets, the dimensional datasets, the spline, the parametric model, or the virtual 3D model.

18. The 3D image modeling system of aspect 17, wherein the GUI is configured to receive user selections to manipulate any of the 2D imaging assets, the dimensional datasets, the spline, the parametric model, or the virtual 3D model.

19. The 3D image modeling system of aspect 18, wherein the one or more processors are further configured to generate or render a new virtual 3D model based on the user selections, the new virtual 3D model representing an updated product or product package corresponding to the user selections.

20. The 3D image modeling system of aspect 19, wherein the one or more processors are further configured to store the virtual 3D model in a memory such that the virtual 3D model is accessible to the imaging asset manipulation script or the visualization editor.

21. The 3D image modeling system of any of aspects 1-19, wherein the computing instructions of the imaging asset manipulation script, when executed by the one or more processors, cause the one or more processors to: extract an alpha channel from the 2D image asset, wherein the shape silhouette is a shape silhouette of the alpha channel extracted from the 2D image asset.

22. A three-dimensional (3D) image modeling method for automatically generating photorealistic, virtual 3D package and product models from two-dimensional (2D) imaging assets and dimensional data, the 3D image modeling method comprising: obtaining, by one or more processors, a shape classification defining a real-world product or product package to be virtually modeled in 3D space, obtaining, by the one or more processors, a dimensional dataset defining product or package measurements of the real-world product or product package to be virtually modeled in 3D space, generating, by the one or more processors, a spline, based on the 2D image asset, wherein the 2D image asset is selected from the 2D imaging assets, and wherein the 2D image asset depicts the real-world product or product package, the spline comprising a plurality of points positioned along a perimeter of a shape silhouette of the real-world product or product package depicted in the 2D image asset, generating, by the one or more processors, a parametric model based on the spline, the dimensional dataset, and the shape classification, generating, by the one or more processors, a virtual 3D model of the real-world product or product package based on the parametric model and one or more attributes corresponding to the real-world product or product package, and rendering, by the one or more processors, via a graphical display or environment, the virtual 3D model as a photorealistic image representing the real-world product or product package in a virtual 3D space.

23. A tangible, non-transitory computer-readable medium storing three-dimensional (3D) image modeling instructions for automatically generating photorealistic, virtual 3D package and product models from two-dimensional (2D) imaging assets and dimensional data, that, when executed by one or more processors, cause the one or more processors to: obtain a shape classification defining a real-world product or product package to be virtually modeled in 3D space, obtain a dimensional dataset defining product or package measurements of the real-world product or product package to be virtually modeled in 3D space, generate a spline, based on the 2D image asset, wherein the 2D image asset is selected from the 2D imaging assets, and wherein the 2D image asset depicts the real-world product or product package, the spline comprising a plurality of points positioned along a perimeter of a shape silhouette of the real-world product or product package depicted in the 2D image asset, generate a parametric model based on the spline, the dimensional dataset, and the shape classification, generate a virtual 3D model of the real-world product or product package based on the parametric model and one or more attributes corresponding to the real-world product or product package, and render, via a graphical display or environment, the virtual 3D model as a photorealistic image representing the real-world product or product package in a virtual 3D space.

Additional Considerations

Although the disclosure herein sets forth a detailed description of numerous different aspects, it should be understood that the legal scope of the description is defined by the words of the claims set forth at the end of this patent and equivalents. The detailed description is to be construed as exemplary only and does not describe every possible aspect since describing every possible aspect would be impractical. Numerous alternative aspects may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain aspects are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example aspects, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various aspects, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering aspects in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiples of such hardware modules exist contemporaneously, communications may be achieved through signal transmission (e.g., over appropriate circuits and buses) that connect the hardware modules. In aspects in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example aspects, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example aspects, the processor or processors may be located in a single location, while in other aspects processors may be distributed across a number of locations.

The performance of certain of the operations may be distributed among the one or more processors, not only residing within a single machine, but deployed across a number of machines. In some example aspects, the one or more processors or processor-implemented modules may be located in a single geographic location (e.g., within a home environment, an office environment, or a server farm). In other aspects, the one or more processors or processor-implemented modules may be distributed across a number of geographic locations.

This detailed description is to be construed as exemplary only and does not describe every possible aspect, as describing every possible aspect would be impractical, if not impossible. A person of ordinary skill in the art may implement numerous alternate aspects, using either current technology or technology developed after the filing date of this application.

Those of ordinary skill in the art will recognize that a wide variety of modifications, alterations, and combinations can be made with respect to the above described aspects without departing from the scope of the invention, and that such modifications, alterations, and combinations are to be viewed as being within the ambit of the inventive concept.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed is:

1. A three-dimensional (3D) image modeling system configured to automatically generate photorealistic, virtual 3D package and product models from two-dimensional (2D) imaging assets and dimensional data, the 3D image modeling system comprising:
one or more processors;
an imaging asset manipulation script comprising computing instructions configured to execute on the one or more processors; and
a memory configured to store 2D imaging assets and dimensional datasets accessible by the one or more processors and the computing instructions of the imaging asset manipulation script,
wherein the computing instructions of the imaging asset manipulation script, when executed by the one or more processors, cause the one or more processors to:
obtain a shape classification defining a real-world product or product package to be virtually modeled in 3D space,
obtain a dimensional dataset defining product or package measurements of the real-world product or product package to be virtually modeled in 3D space,
generate a spline, based on a 2D image asset, wherein the 2D image asset is selected from the 2D imaging assets, and wherein the 2D image asset depicts the real-world product or product package, the spline comprising a plurality of points positioned along a perimeter of a shape silhouette of the real-world product or product package depicted in the 2D image asset,
generate a parametric model based on the spline, the dimensional dataset, and the shape classification,
generate a virtual 3D model of the real-world product or product package based on the parametric model and one or more attributes corresponding to the real-world product or product package, and
render, via a graphical display or environment, the virtual 3D model as a photorealistic image representing the real-world product or product package in a virtual 3D space.

2. The 3D image modeling system of claim 1, wherein the shape classification comprises at least one of: a bottle classification, a symmetrical pump classification, a tube classification, a symmetrical bottle classification, a tottle classification, an asymmetrical bottle classification, a box classification, a pouch classification, a bag classification, a handled bottle classification, or a blister pack classification.

3. The 3D image modeling system of claim 1, wherein the computing instructions of the imaging asset manipulation script, when executed by the one or more processors, cause the one or more processors to:
adjust the spline to optimize the mapping of the spline to the alpha channel or reduce the data size the spline by reducing or adjusting one or more of the plurality of points positioned along the perimeter of the alpha channel.

4. The 3D image modeling system of claim 1, wherein the computing instructions of the imaging asset manipulation script, when executed by the one or more processors, cause the one or more processors to:
generate, based on the 2D image asset, a UV graphical texture defining at least one of: a first graphical representation or a second graphical representation of the real-world product or product package.

5. The 3D image modeling system of claim 4, wherein each of the first graphical representation and the second graphical representation are generated as a different graphical representation or a same graphical representation for rendering as a virtual first side UV texture and a virtual second side UV texture of the virtual 3D model of the real-world product or product package.

6. The 3D image modeling system of claim 1, wherein the spline is a first spline, comprising a plurality of points positioned along a perimeter of a first shape silhouette of a first portion of the real-world product or product package depicted in the 2D image asset, and wherein the computing instructions of the imaging asset manipulation script, when executed by the one or more processors, cause the one or more processors to:
generate a second spline comprising a plurality of points positioned along a perimeter of a second shape silhouette of the second portion of the real-world product or product package depicted in the 2D image asset.

7. The 3D image modeling system of claim 6, wherein the computing instructions of the imaging asset manipulation script, when executed by the one or more processors, cause the one or more processors to:
add a first graphical texture or a first color to the first portion of the real-world product or product package to be virtually modeled in 3D space;
add a second graphical texture or a second color to the second portion of the real-world product or product package to be virtually modeled in 3D space, the second graphical texture or the second color being different from the first graphical texture or the first color.

8. The 3D image modeling system of claim 6, wherein the computing instructions of the imaging asset manipulation script, when executed by the one or more processors, cause the one or more processors to:
add a first graphical texture or a first color to the first portion of the real-world product or product package to be virtually modeled in 3D space;
add a second graphical texture or a second color to the second portion of the real-world product or product package to be virtually modeled in 3D space, the second graphical texture or the second color being consistent the first graphical texture or the first color.

9. The 3D image modeling system of claim 1, wherein the computing instructions of the imaging asset manipulation script, when executed by the one or more processors, cause the one or more processors to:
update the spline or the parametric model by applying one or more refinements.

10. The 3D image modeling system of claim 9, wherein one or more points of the spline or the parametric model are configured to be selected or dragged, and wherein the one or imaging refinements comprise receiving a selection or drag command to adjust or reduce the one or more points of the spline or the parametric model.

11. The 3D image modeling system of claim 9, wherein one or more image features are configured to be adjusted for or applied to the virtual 3D model, and wherein the one or refinements comprise receiving an adjustment or application command to update the virtual 3D model.

12. The 3D image modeling system of claim 1, wherein the virtual 3D model is a high fidelity polygonal model representation of the real-world product or product package.

13. The 3D image modeling system of claim 1, wherein the computing instructions of the imaging asset manipulation script, when executed by the one or more processors, cause the one or more processors to:
initiate creation of at least a portion of the real-world product or product package based on the virtual 3D model.

14. The 3D image modeling system of claim 13, wherein the computing instructions of the imaging asset manipulation script, when executed by the one or more processors, cause the one or more processors to:
create, with a 3D printer, at least a portion of the real-world product or product package based on the virtual 3D model.

15. The 3D image modeling system of claim 12, wherein the high fidelity polygonal model is rendered in the virtual 3D space as part of a mixed reality environment.

16. The 3D image modeling system of claim 1 further comprising a server comprising at least one processor of the one or more processors, wherein at least a portion of 2D imaging assets and dimensional datasets are retrieved via a computing network.

17. The 3D image modeling system of claim 1, wherein the one or more processors are further configured to launch a graphical user interface (GUI), the GUI configured to load into memory, or render on the graphical display, any one or more of the 2D imaging assets, the dimensional datasets, the spline, the parametric model, or the virtual 3D model.

18. The 3D image modeling system of claim 17, wherein the GUI is configured to receive user selections to manipulate any of the 2D imaging assets, the dimensional datasets, the spline, the parametric model, or the virtual 3D model.

19. The 3D image modeling system of claim 18, wherein the one or more processors are further configured to generate or render a new virtual 3D model based on the user selections, the new virtual 3D model representing an updated product or product package corresponding to the user selections.

20. The 3D image modeling system of claim 19, wherein the one or more processors are further configured to store the virtual 3D model in a memory such that the virtual 3D model is accessible to the imaging asset manipulation script or the visualization editor.

21. The 3D image modeling system of claim 1, wherein the computing instructions of the imaging asset manipulation script, when executed by the one or more processors, cause the one or more processors to:
extract an alpha channel from the 2D image asset, wherein the shape silhouette is a shape silhouette of the alpha channel extracted from the 2D image asset.

22. A three-dimensional (3D) image modeling method for automatically generating photorealistic, virtual 3D package and product models from two-dimensional (2D) imaging assets and dimensional data, the 3D image modeling method comprising:
obtaining, by one or more processors, a shape classification defining a real-world product or product package to be virtually modeled in 3D space,
obtaining, by the one or more processors, a dimensional dataset defining product or package measurements of the real-world product or product package to be virtually modeled in 3D space,
generating, by the one or more processors, a spline, based on the 2D image asset, wherein the 2D image asset is selected from the 2D imaging assets, and wherein the 2D image asset depicts the real-world product or product package, the spline comprising a plurality of points positioned along a perimeter of a shape silhouette of the real-world product or product package depicted in the 2D image asset,
generating, by the one or more processors, a parametric model based on the spline, the dimensional dataset, and the shape classification,
generating, by the one or more processors, a virtual 3D model of the real-world product or product package based on the parametric model and one or more attributes corresponding to the real-world product or product package, and
rendering, by the one or more processors, via a graphical display or environment, the virtual 3D model as a photorealistic image representing the real-world product or product package in a virtual 3D space.

23. A tangible, non-transitory computer-readable medium storing three-dimensional (3D) image modeling instructions for automatically generating photorealistic, virtual 3D package and product models from two-dimensional (2D) imaging assets and dimensional data, that, when executed by one or more processors, cause the one or more processors to:
obtain a shape classification defining a real-world product or product package to be virtually modeled in 3D space,
obtain a dimensional dataset defining product or package measurements of the real-world product or product package to be virtually modeled in 3D space,
generate a spline, based on the 2D image asset, wherein the 2D image asset is selected from the 2D imaging assets, and wherein the 2D image asset depicts the real-world product or product package, the spline comprising a plurality of points positioned along a perimeter of a shape silhouette of the real-world product or product package depicted in the 2D image asset,
generate a parametric model based on the spline, the dimensional dataset, and the shape classification,
generate a virtual 3D model of the real-world product or product package based on the parametric model and one or more attributes corresponding to the real-world product or product package, and
render, via a graphical display or environment, the virtual 3D model as a photorealistic image representing the real-world product or product package in a virtual 3D space.
